(19) United States
(12) Patent Application Publication
(10) Pub. No.: US 2007/0140914 A1
(43) Pub. Date: Jun. 21, 2007

(54) Reagent-introducing medical device configured to create laminar flow and rotating flow

(76) Inventors: Yoshiki Sawa, Hyogo Pref, (JP); Satoshi Taketani, Osaka (JP); Yoshiho Toyota, Moriyama-ku (JP); Shinji Ozawa, Moriyama-ku (JP); Nobuyoshi Watanabe, Moriyama-ku (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/314,493

(22) Filed: Dec. 21, 2005

(51) Int. Cl. B01L 3/02

(52) U.S. Cl. 422/100

(57) ABSTRACT

The invention provides a reagent-introducing medical device that can guide a reagent into a reagent injector while maintaining all biological materials contained in the reagent in a healthy state. In an embodiment of the reagent-introducing medical device, an apparatus body (12) comprises a channel (77, 78, 80, 50e) through which a reagent flows, as well as a reagent inlet (76) and outlet (21), and further comprises a first control mechanism (58, 64) for controlling the flow of the reagent to create a laminar reagent flow in the channel (77, 78, 80, 50e) and a second control mechanism (70) for further controlling the laminar reagent flow in the channel to create a rotational reagent flow.

### BACKGROUND OF THE INVENTION

1. Field of the Invention

The present invention relates to a reagent-introducing medical device, and more specifically to a reagent-introducing medical device that introduces a reagent, while controlling its flow, into a reagent injector that injects the reagent into the patient body.

2. Description of the Related Art

Traditionally, various treatments, tests, procedures and other operations have been performed by means of inserting a specified medical apparatus into the target blood vessel, gastrointestinal tract, urinal tract or other tubular organ or tissue in the human body. Recent years have seen an emergence of treatments, procedures and other operations that revive virtually necrotic tissues of lesions in the cardiac muscle, etc., by inserting a catheter or other reagent injector into the patient body and then injecting a reagent containing biological materials such as cells, as disclosed for example in Japanese Publication of Unexamined Patent Application No. 2003-250899. These reagents are also injected into body tissues using syringes and other reagent injectors.

When these reagent injectors are used, generally a syringe or other similar apparatus is used to introduce or supply a reagent into the reagent injector. Accordingly, various innovative features have been added to the structures of these syringes to achieve smoother reagent introduction into the reagent injector. Examples thereof are disclosed in, for example, Japanese Publication of Unexamined Patent Application No. 2000-325477 and Japanese Publication of Unexamined Patent Application No. Hei 7-194701.

### SUMMARY OF THE INVENTION

However, the inventors of the present invention examined these conventional modified syringes from various viewpoints and found that these syringes would present problems if used as introduction (supply) apparatuses for reagents containing biological materials.

It is a well-known fact that reagents containing biological materials such as cells are delicate in nature and expensive. Therefore, these reagents must be introduced into reagent injectors in such a way that as much biological material as possible contained in the reagent is introduced into the reagent injector without sustaining damage, so that all of the biological materials in the reagent will be injected into the patient body in a healthy state.

However, it was extremely difficult to achieve the desired survival rate of biological materials in the patient body when a reagent containing biological materials was introduced into a reagent injector using any conventional syringe. In addition, it was unavoidable that, after the entire reagent was introduced into the reagent injector, a lot of biological materials remained attached to the interior surface of the syringe and thus stayed inside the syringe.

Therefore, conventional syringes could not possibly satisfy the demand regarding apparatuses that introduce or supply reagents containing biological materials into reagent injectors. For this reason, there has been a strong demand for further improvement of these apparatuses.

An object of the present invention is to provide a reagent-introducing medical device that can be used with a reagent injector to supply a specified reagent, such as a reagent containing biological materials, into the patient body in a manner while allowing as much biological material as possible to be introduced into the reagent injector in a healthy state.

To solve the aforementioned problems, the inventors of the present invention explored the causes of lower survival rates of biological material in the patient bodies and attachment of biological materials to the interior surfaces of syringes and other reagent introduction apparatuses. While studying the problem, the inventors studied the reagent flow through the channel in the reagent introduction apparatus. As a result, it was revealed that, in the event of occurrence of turbulence in the reagent flow in the channel, biological materials such as cells would easily be damaged and that the amount of biological materials attached to the interior walls of the channel would also increase.

Based on these findings, the inventors of the present invention learned that damage to biological materials could be reduced in an advantageous manner by controlling the reagent flow in the channel in such a way that it follows a parabolic velocity distribution where the velocity becomes the highest at the center of the flow (channel) and decreases toward both ends (interior walls of the channel). It was also discovered that the amount of biological materials attached to the interior walls of the channel could be reduced by way of increasing the differential speed of flow between the center and both ends. Without being limited to a particular scientific principle underlying this finding, the effect is probably due to the fact that, when a reagent flows through the channel, biological materials in the reagent tend to collect in the area of faster flow, namely at the center of the channel, and therefore contact between the reagent and interior walls of the channel is effectively eliminated or suppressed.

Consequently, in an aspect, an object of the present invention is to provide a reagent-introducing medical device for controlling the injection of a reagent into the human body, comprising: an apparatus body having a channel through which the reagent flows, an inlet through which the reagent enters the channel, and an outlet through which the reagent exits from the channel; and a first control mechanism configured to cause laminar flow of the reagent through the channel in the apparatus body.

In a further aspect, the invention provides a reagent-introducing medical device further comprising a second control mechanism configured to apply rotational motion to the reagent flow through the channel in the apparatus body.

In a further aspect, the invention provides a reagent-introducing medical device wherein the second control mechanism comprises flow-regulating surfaces that contact the reagent flowing through the channel in the apparatus body and change the flow direction of the reagent, each of the flow-regulating surfaces having a curved surface formed by twisting a plane parallel with the flow direction of the reagent around an axis running in parallel with the flow direction.

In a further aspect, the invention provides a reagent-introducing medical device wherein the second control mechanism comprises flow-regulating surfaces that contact the reagent flowing through the channel in the apparatus body and change the flow direction of the reagent, each of the flow-regulating surfaces having a curved surface extending spirally along the flow direction of the reagent.

In a further aspect, the invention provides a reagent-introducing medical device wherein the cross-sectional areas of at least the inlet and the outlet are configured to maintain the maximum Reynolds number of the reagent flowing through the channel below the Reynolds number at which the reagent flow changes from laminar flow to turbulent flow, and wherein the first control mechanism comprises a flow-rate control mechanism, for controlling the flow rate of the reagent by limiting the cross-section area of the channel using a channel cross-section area limiting mechanism.

In a further aspect, the invention provides a reagent-introducing medical device wherein the first control mechanism maintains the maximum Reynolds number of the reagent flowing through the channel within a range of about 50 to less than about 2,300.

In a further aspect, the invention provides a reagent-introducing medical device wherein the channel cross-section area limiting mechanism comprises a plunger member arranged inside the channel in such a way that it moves in the direction of separating from the inlet when the reagent flows into the channel, while the flow-rate control mechanism comprises the plunger member and an elastic member that applies a force to the inlet side of the plunger member.

In a further aspect, the invention provides a reagent-introducing medical device wherein the plunger member and the elastic member are integrated with each other.

In a further aspect, the invention provides a reagent-introducing medical device wherein the elastic member is positioned at the inlet and between the apparatus body and the plunger member.

In a further aspect, the invention provides a reagent-introducing medical device wherein the plunger member is configured to block the inlet when the reagent does not flow into the channel.

In a further aspect, the invention provides a reagent-introducing medical device wherein the second control mechanism comprises flow-regulating surfaces that change the flow direction of the reagent, each of the flow-regulating surfaces having a curved surface formed by twisting a plane parallel with the flow direction of the reagent around an axis running in parallel with the flow direction.

In a further aspect, the invention provides a reagent-introducing medical device wherein the second control mechanism comprises flow-regulating surfaces that change the flow direction of the reagent, each of the flow-regulating surfaces having a curved surface extending spirally along the flow direction of the reagent.

In a further aspect, the invention provides a reagent-introducing medical device for controlling the injection of a reagent into the human body, comprising: an approximately cylindrical apparatus body that introduces the reagent from an inlet and discharges the reagent from an outlet; a plunger member arranged inside the apparatus body in such a way that it moves in the direction of separation from the inlet when the reagent is introduced from the inlet; a rotational-flow generation mechanism installed on the plunger member and causing the reagent introduced into the apparatus body to form a rotational flow inside the apparatus body; and an elastic member positioned between the plunger member and the apparatus body and applying a force to the inlet side of the plunger member.

In a further aspect, the invention provides a reagent-introducing medical device wherein the rotational-flow generation mechanism comprises a modified polygonal cylinder formed by twisting a polygonal cylinder extending in the axial direction of the plunger by a specified angle around the center of axis of the plunger, and wherein the polygonal cylinder comes into contact with the reagent flowing in the apparatus body and imparts a rotational flow thereto.

In a further aspect, the invention provides a reagent-introducing medical device wherein the plunger member comprises a body having an approximately cylindrical exterior periphery.

In a further aspect, the invention provides a method for controlling the injection of a reagent into a human body, comprising causing the reagent to pass through a channel configured to cause laminar flow of the reagent before injection of the reagent into the human body.

In a further aspect, the invention provides a method for controlling the injection of a reagent into a human body, further comprising imparting rotational motion to the reagent as it passes through said channel.

In a further aspect, the invention provides a method for controlling the injection of a reagent into a human body, wherein the maximum Reynolds number of the reagent flowing through the channel is maintained within a range of about 50 to less than about 2,300.

In all of the aforesaid embodiments, any element used in an embodiment can be interchangeably or additionally be used in another embodiment unless such a replacement is not feasible or causes adverse effects. Further, the present invention can be applied to apparatuses and methods.

For purposes of summarizing the invention and the advantages achieved over the related art, certain objects and advantages of the invention have been described above. Of course, it is to be understood that not necessarily all such objects or advantages may be achieved in accordance with any particular object of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features, and advantages of this invention will become apparent from the detailed description of the preferred embodiments which follow.

### BRIEF DESCRIPTION OF THE DRAWINGS

FIG. 1 is a schematic diagram showing a front view of an embodiment of a reagent-introducing medical device in accordance with the present invention, illustrating a mode of use in which the aforementioned apparatus is placed between a syringe and a reagent injection catheter.

FIG. 2 shows a partially enlarged view, taken along II-II of FIG. 1, illustrating the vertical cross-section of the reagent-introducing medical device shown in FIG. 1.

FIG. 3 shows an enlarged front view of the plunger cap stored in the cylindrical body of the reagent-introducing medical device shown in FIG. 1.

FIG. 4 shows a view taken along IV-IV of FIG. 3.

FIG. 5 shows an enlarged front view of the plunger member stored in the cylindrical body of the reagent-introducing medical device shown in FIG. 1.

FIG. 6 shows an enlarged view from the vantage point labeled VI in FIG. 5.

FIG. 7 shows a partially enlarged cross-sectional view illustrating a mode of use of the reagent-introducing medical device shown in FIG. 1.

FIG. 8 shows a velocity distribution model of reagent flowing through the cylindrical body of the reagent-introducing medical device shown in FIG. 1.

FIG. 9 illustrates another example of a reagent-introducing medical device conforming to the present invention.

FIG. 10 shows a partially enlarged cross-sectional view of the cylindrical body in another embodiment of a reagent-introducing medical device conforming to the present invention.

FIG. 11 shows a partially enlarged view of the plunger member in a different embodiment of a reagent-introducing medical device conforming to the present invention.

An explanation of the symbols used in the figures is as follows:

| | |
|---|---|
| 10 | Reagent-introducing medical device |
| 12 | Cylindrical body |
| 14 | Syringe |
| 16 | Reagent injection catheter |
| 21 | Second opening |
| 40 | Connector |
| 50 | Internal bore |
| 54 | Plunger cap |
| 56 | Through hole |
| 58 | Plunger member |
| 60 | Body |
| 62 | Flow-regulating part |
| 64 | Connection member |
| 70 | Flow-regulating surface (Pressure-control valve) |
| 72 | Extension/contraction part |
| 76 | Circular hole |
| 77 | Circular gap |
| 78 | Cylindrical gap |
| 80 | Space |
| 81 | Reagent |

### DETAILED DESCRIPTION OF THE PREFERRED EMBODIMENT

The present invention will be illustrated below with respect to preferred embodiments. However, the embodiments are not intended to limit the present invention.

To describe the present invention in a more specific manner, the structures of reagent-introducing medical devices in accordance with the present invention will be explained in detail using the figures.

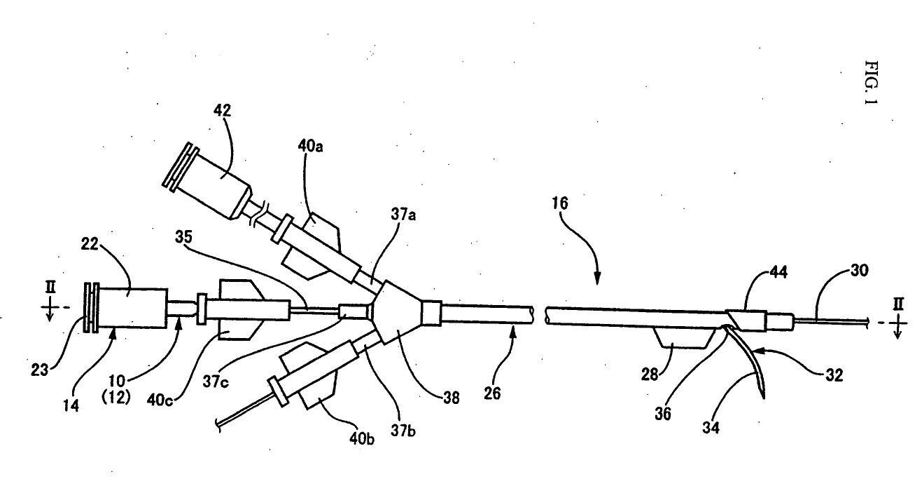

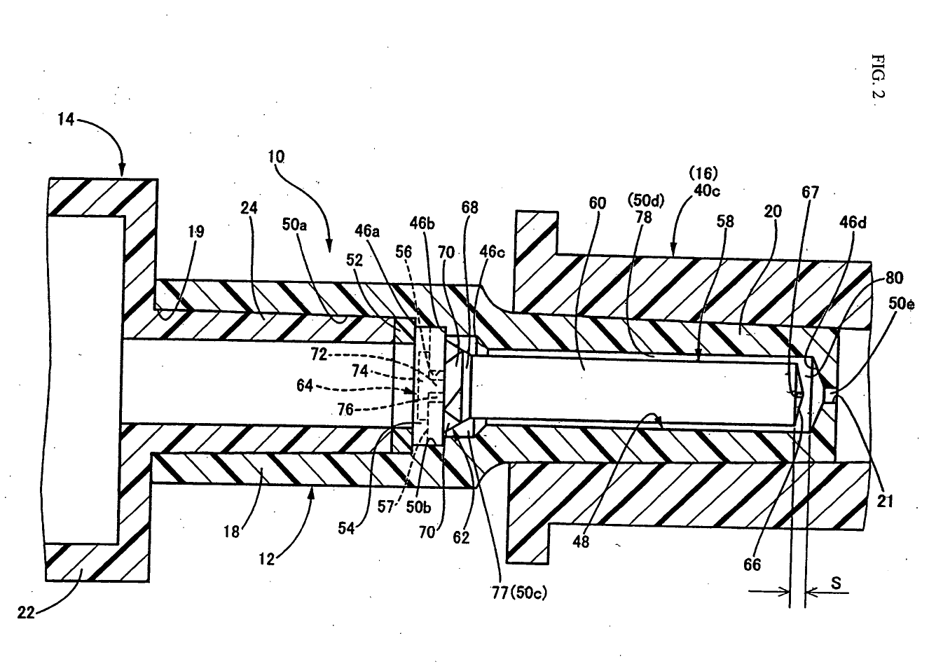

First, FIGS. 1 and 2 show a front view and an axial-direction cross-section view of one embodiment of a reagent-introducing medical device in accordance with the present invention. This reagent-introducing medical device is used in conjunction with a reagent injection catheter that connects to the reagent-introducing medical device and injects a reagent containing biological materials such as cells into lesions in the cardiac muscle and the like. As can be seen in these drawings, this embodiment of the reagent-introducing medical device (10) has an approximately cylindrical body (12) as the apparatus body. One end of this cylindrical body (12) in the axial direction is connected to a reagent injection catheter (16) that functions as a reagent injector. The other end of the cylindrical body (12) in the axial direction is connected to a syringe (14) that supplies a reagent into the reagent injection catheter (16). In other words, the reagent-introducing medical device (10) is placed between the syringe (14) and reagent injection catheter (16) so that the reagent discharged by the syringe (14) is introduced into the reagent injection catheter (16). Note that, in the following explanation, the end of the reagent-introducing medical device (10) connected to the syringe (14) (the left side in FIGS. 1 and 2) is referred to as the rear side, while the end connected to the regent injection catheter (16) (the right side in FIGS. 1 and 2) is referred to as the front side, based on the direction of reagent flow.

Here, the syringe (14) has a well-known structure that allows a reagent containing biological materials to be supplied manually, electrically or by other means. To be specific, the syringe (14) has a cylinder (22) that stores a reagent, a nozzle (24) formed integrally at the tip of the cylinder (22), and a piston (23) that pushes out the reagent in the cylinder (22) through the nozzle (24). This nozzle (24) is inserted into, and connected with, the cylindrical body (12) of the reagent-introducing medical device (10).

Normally, reagents containing valuable biological materials are not used in large quantities. Therefore, the cylinder (22) equipped in this syringe (14) has a capacity of approximately 1 mL (milliliter). The biological materials that may be contained in reagents supplied using such syringe (14) include osteoblasts, ES cells, mesenchymal cells, hepatic cells and other cells used for reviving virtually necrotic cardiac muscle tissues, as well as bFGF (basic Fibroblast Growth Factor), VEGF (Vascular Endothelial Growth Factor), HGF (Hepatic Growth Factor) and other growth factors. Other biological materials include cytokines such as interleukin 1 (IL-1) through interleukin 13 (IL-13), proteins derived from organisms, DNA, RNA, and mRNA.

Meanwhile, the reagent injection catheter (16) also has a traditionally known structure that allows a reagent containing biological materials to be injected into lesions in the cardiac muscle and the like. To be specific, this reagent injection catheter (16) has: a catheter body (26) comprising a long tube that may be inserted into blood vessels and the like; first, second and third lumens (not shown) that are formed in this catheter body (26) in a manner extending in the longitudinal direction of the catheter body; a balloon (28) that inflates when the saline solution or other liquid supplied from outside through the first lumen enters the balloon; and a guide wire (30) and a needle tube body (32) inserted into the second lumen and third lumen, respectively, in a manner so as to be movable in the axial direction of each lumen.

The guide wire (30) can be extended outward through the tip opening provided at the tip surface of the catheter body (26). The needle tube body (32) comprises a thin tube with, in this embodiment, a diameter of approximately 0.4 mm that is flexible over its entire length and through which the reagent is able to flow. A needle (34) is provided at the tip of the needle tube body (32). The entire area of the needle tube body (32), except for this needle (34), defines a reagent channel (35) that leads the reagent to the needle (34). When the reagent channel (35) of this needle tube body (32) moves inside the third lumen in the axial direction of the catheter body (26), the needle (34) either protrudes outward from a projection aperture (36) provided in the side face at the tip of the catheter body (26) (at the right end in FIG. 1), or is retracted into the third lumen.

At the rear end of the catheter body (26) (at the left end in FIG. 1), a branching socket (38) having first, second and third branching paths (37a, 37b, 37c) is provided, where these branching paths divide the catheter body (26) into three and connect to the three lumens inside the catheter body (26), respectively. Furthermore, connectors (40a, 40b) are attached at the tips of the first and second branching paths (37a, 37b) in this branching socket (38). Of these two connectors (40a, 40b), the connector (40a) attached to the first branching path (37a) has a syringe (42) that supplies a liquid to the balloon (28) through the first lumen. The guide wire (30) is inserted into the second lumen through the connector (40b) attached to the second branching path (37b).

Furthermore, the needle tube body (32) is inserted into the third lumen through the third branching path (37c), with the rear end projecting outward. Also, a connector (40c) is attached at the rear end of the needle tube body (32) in a linked state. Inserted into this connector (40c) is the cylindrical body (12) of the reagent-introducing medical device (10) to which the syringe (14) for supplying the reagent to the needle tube body (32) is connected. In FIG. 1, numeral 44 indicates a marker affixed near the projection aperture (36). This marker (44) can be formed using any radio-opaque material such as gold, platinum or platinum rhodium alloy.

The reagent injection catheter (16) having the above structure is used in the same manner as traditional reagent injection catheters when injecting a reagent into lesions in the cardiac muscle and the like. Specifically, the guide wire (30) is inserted into the target blood vessel in the cardiac muscle, for example. Next, the catheter body (26) is guided by this guide wire (30) and inserted into the blood vessel. At this time, the position of the marker (44) in the blood vessel is confirmed using X-ray imaging or the like. This way, the position of the projection aperture (36) in the blood vessel is determined. When the projection aperture (36) reaches the desired position in the blood vessel, the balloon (28) is inflated and the position of the catheter body (26) is affixed. Thereafter, the needle tube body (32) is moved inside the third lumen in the catheter body (26), and the needle (34) is projected outward from the projection aperture (36). This causes the needle (34) to puncture the desired location of the cardiac muscle. Then, a reagent is supplied from the syringe (14) into the needle tube body (32) via the reagent-introducing medical device (10), and then injected into the desired location of the cardiac muscle via the needle (34).

The cylindrical body (12) of the reagent-introducing medical device (10) placed between the syringe (14) and reagent injection catheter (16), as mentioned earlier, is made of polyethylene, polypropylene, polyacetal, polyamide, polysulfone or other resin material, for example. Also, as shown in FIG. 2, this cylindrical body (12) has a stepped cylinder shape overall where the outer diameter at one end (rear side) in the axial direction (front-rear direction) is larger than the outer diameter at the other end (front side). The nozzle (24) of the syringe (14) is inserted into the rear side having the larger diameter to form a first connection part (18). On the other hand, the connector (40c) on the reagent injection catheter (16) is inserted over the front side having the smaller diameter to form a second connection part (20). Furthermore, the opening at the rear (side of the first connection part (18)) of this cylindrical body (12) becomes a first opening (19) having a large diameter, while the opening at the front (side of the second connection part (20)) becomes a second opening (21) having a small diameter.

Here, a part of the interior periphery of the first connection part (18) (interior periphery of a first internal bore (50a) explained later) and the exterior periphery of the second connection part (20) are tapered in accordance with the tapered outer periphery of the nozzle (24) of the syringe (14) and tapered interior periphery of the connector (40c), respectively. This way, the nozzle (24) of the syringe (14) is inserted into the first connection part (18) under pressure. The second connection part (20) is also inserted into the connector (40c) under pressure.

The outer diameter of the first connection part (18) of this cylindrical body (12) is approximately 6.0 mm (typically about 3.0 mm to about 8.0 mm), while its maximum inner diameter is approximately 3.9 mm (typically about 3.0 mm to about 4.0 mm). The length is approximately 10.0 mm (typically about 6.0 mm to about 20.0 mm), which is longer by a specified dimension than the length of the nozzle (24) of the syringe (14). On the other hand, the minimum outer diameter of the second connection part (20) is approximately 3.9 mm (typically about 3.0 mm to about 4.0 mm), while its length is approximately 11.0 mm (typically about 6.0 mm to about 20.0 mm). The diameters, lengths and other dimensions of these first connection part (18) and second connection part (20) can be changed as deemed appropriate in accordance with the diameters, lengths and other dimensions of the nozzle (24) of the syringe (14) and connector (40c) on the reagent injection catheter (16).

This cylindrical body (12) has four circular stepped surfaces, known as the first, second, third and fourth circular stepped surfaces (46a, 46b, 46c, 46d) that are formed on the interior periphery of the cylindrical body at given intervals apart in the axial direction (front-rear direction). These four circular stepped surfaces (46a to 46d) have gradually decreasing diameters, where the circular stepped surface located at the frontmost position has the smallest diameter. Accordingly, an internal bore (48) with a circular cross-section provided in the cylindrical body (12) comprises a first internal bore (50a) defined by the section to the rear of the first circular stepped surface (46a), a second internal bore (50b) defined by the section between the first circular stepped surface (46a) and second circular stepped surface (46b), a third internal bore (50c) defined by the section between the second circular stepped surface (46b) and third circular stepped surface (46c), a fourth internal bore (50d) defined by the section between the third circular stepped surface (46c) and fourth circular stepped surface (46d), and a fifth internal bore (50e) defined by the section to the front of the fourth circular stepped surface (46d). These five internal bores (50a to 50e) have gradually decreasing inner diameters, where the internal bore located at the frontmost position has the smallest diameter.

Here, the interior periphery of the first internal bore (50a) is tapered as mentioned earlier, where the maximum inner diameter and length of the first internal bore (50a) are approximately 3.9 mm (typically about 3.0 mm to about 4.0 mm) and approximately 8.0 mm, respectively. The inner diameter and length of the second internal bore (50b) are approximately 3.5 mm (typically about 3.0 mm to about 4.0 mm) and approximately 1.0 mm (typically about 1.0 mm to about 3.0 mm), respectively. The inner diameter of the third internal bore (50c) is approximately 3.0 mm. The inner diameter of the fourth internal bore (50d) is approximately 2.0 mm (typically about 2.0 mm to about 3.0 mm). The inner diameter of the fifth internal bore (50e) is approximately 0.5 mm (typically about 0.4 mm to about 2.0 mm). The total length of the third internal bore (50c), fourth internal bore (50d) and fifth internal bore (50e), or the length of the channel explained later, thus becomes approximately 12.0 mm (typically about 6.0 mm to about 2.0 mm).

The inner diameters and lengths of these internal bores (50a-50e) are not specifically limited, either, and they can be changed as deemed appropriate in accordance with the diameter, length and other dimension of the nozzle (24) of the syringe (14) connected to the first connection part (18) and the connector (40c) connected to the second connection part (20). Within the internal bores (50a-50e), the areas through which a reagent flows form a so-called dead space where the biological materials contained in the reagent may remain after the entire reagent volume has been supplied and introduced into the connector (40c) from the syringe (14). To minimize such dead space, it is desirable that the lengths of the internal bores (50a-50e) through which a reagent flows be minimized.

Of the four circular stepped surfaces (46a to 46d) forming these five internal bores (50a to 50e), the third circular stepped surface (46c) has a tapered surface whose diameter decreases gradually toward the front of the cylindrical body (12), and is formed on the interior periphery at the step between the first connection part (18) and second connection part (20). On the other hand, the first and second circular stepped surfaces (46a, 46b) have a circular surface perpendicular to the axial direction of the cylindrical body (12), and are formed near the third circular stepped surface (46c) on the interior periphery of the first connection part (18) of the cylindrical body (12). Furthermore, the fourth circular stepped surface (46d) has a tapered shape similar to that of the third circular stepped surface (46c), and is formed near the second opening (21) of the cylindrical body (12) on the interior periphery of the second connection part (20).

This way, a majority of the internal bore section at the first connection part (18) of the cylindrical body (12) is defined by the first internal bore (50a), where this first internal bore (50a) opens outward (in a linked state) through the first opening (19). The remaining internal bore section at the first connection part (18), excluding the first internal bore (50a), is defined by the second internal bore (50b) and third internal bore (50c). On the other hand, a majority of the internal bore section at the second connection part (20) of the cylindrical body (12) is defined by the fourth internal bore (50d). Furthermore, the remaining internal bore section at the second connection part (20), excluding the fourth internal bore (50d), is defined by the fifth internal bore (50e), where this fifth internal bore (50e) opens outward as the second opening (21).

Here, the nozzle (24) of the syringe (14) is inserted into the first internal bore (50a) under pressure. In the first internal bore (50a) in which the nozzle (24) is inserted, a seal ring (52) made of elastic material such as synthetic resin is press-fit via the nozzle (24) and compressed between the tip surface of the nozzle and the first circular stepped surface (46a), with the seal ring stored with its exterior periphery contacting the inner periphery of the first internal bore (50a). By means of this seal ring, the first connection part (18) of the cylindrical body (12) is securely connected to the nozzle (24) of the syringe (14). Under this connection condition, a reagent is reliably supplied from the syringe (14) into the cylindrical body (12) via the nozzle (24) without leaking from the structure.

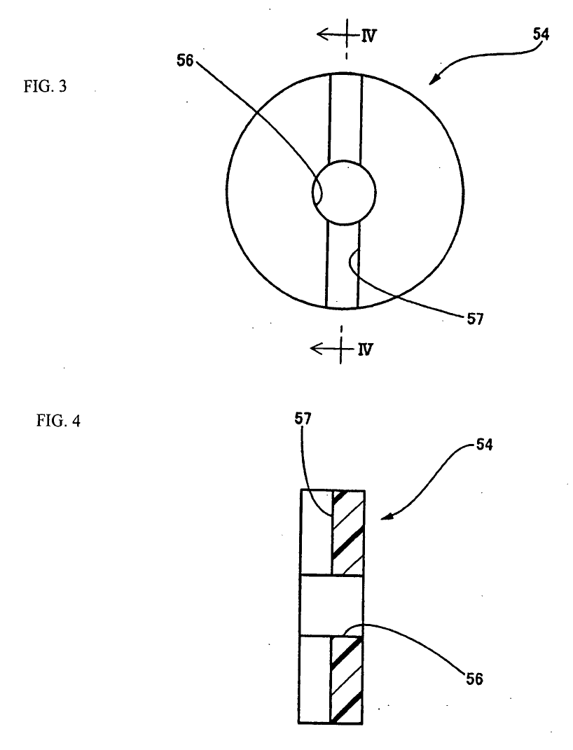

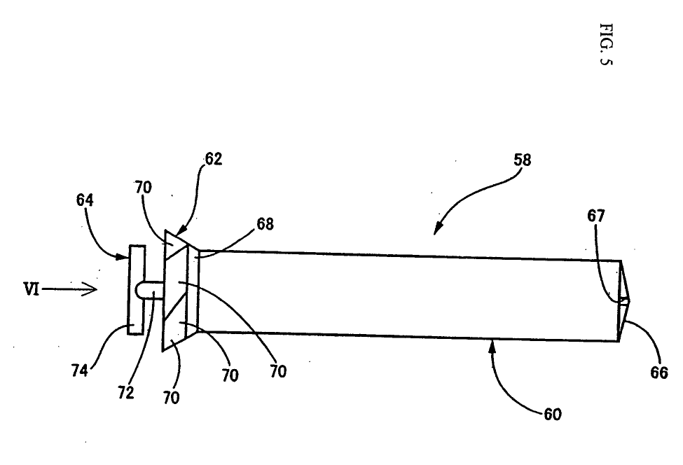

In the second internal bore (50b), a plunger cap (54) made of polyethylene, polypropylene, polyacetal, polyamide, polysulfone or other resin material is stored and arranged as a blocking member. This plunger cap (54) has a thick disk shape overall, as shown in FIGS. 2 to 4, and its outer diameter is adjusted to a size slightly less than 3.5 mm (typically about 3.0 mm to about 4.0 mm) so that the plunger cap can be fitted into the second internal bore (50b). The thickness of this cap is 1.0 mm, which is roughly the same as the axial-direction length of the second internal bore (50b).

Formed inside this plunger cap (54) is a through hole (56) opening at the center of the cap in the thickness direction. On one surface of the cap, a groove (57) passing through the cap center and extending radially is formed. The inner diameter of this through hole (56) is approximately 1.0 mm. The width and depth of the groove (57) are both approximately 0.5 mm. Of course, the dimensions of this plunger cap (54) are not limited to the values mentioned above.

This plunger cap (54) is stored inside the second internal bore (50b), with its side having the groove (57) facing the rear and its exterior periphery contacting the interior periphery of the cylindrical body (12). In this condition, the exterior periphery of the rear end face is contacting the seal ring (52) stored in the first internal bore (50a). Furthermore, the exterior periphery of the front end face opposite to the surface having the groove (57) is contacting the second circular stepped surface (46b). This way, movement of the plunger cap (54) is inhibited inside the second internal bore (50b). Also, the connection part between the first internal bore (50a) and second internal bore (50b) is blocked by the entire part of the plunger cap (54) excluding the through hole (56). In other words, the first internal bore (50a) connects to the third, fourth and fifth internal bores (50c, 50d, 50e) only through the through hole (56). This way, the reagent discharged from the nozzle (24) of the syringe (14), which is inserted into and connected with the first internal bore (50a), is guided into the third through fifth internal bores (50c to 50e) via the through hole (56) in the plunger cap (54).

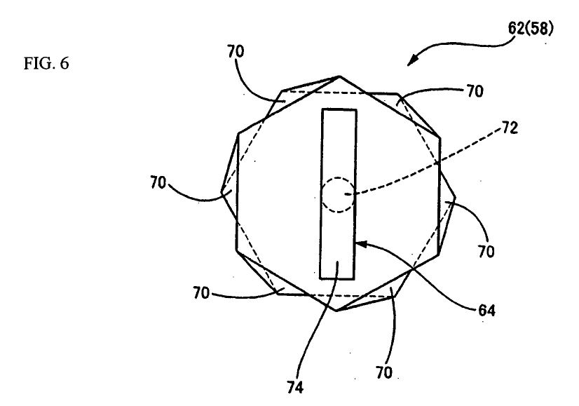

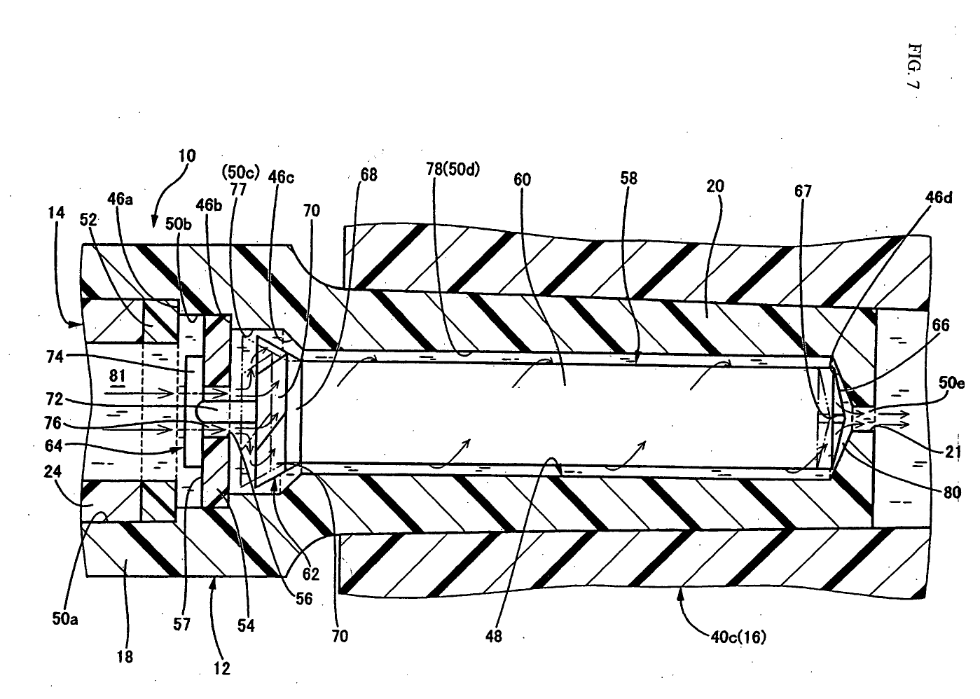

In the third and fourth internal bores (50c, 50d), a plunger member (58) is stored in a manner spanning over these internal bores and extending in the front-rear direction. This plunger member (58) comprises a body (60) and a flow-regulating part (62), which are both integrated with the plunger, as shown in FIGS. 5 and 6. The flow-regulating part (62) of the plunger member (58) also has an integrally provided connection member (64) that functions as an elastic member and extends from the rear end face.

This body (60) of the plunger member (58) is made of polyethylene, polypropylene, polyacetal, polyamide, polysulfone or other resin material, and its overall shape is roughly a column having a cylindrical exterior periphery. On this body (60), the front end that is positioned forward of the cylindrical body (12) when the plunger member is placed inside the third and fourth internal bores (50c, 50d) provides a front-end tapered surface (66) having a tapered surface shape whose taper angle is larger (with respect to an axis of cylindrical body (12)) than that of the fourth circular stepped surface (46d) having a tapered surface on the cylindrical body (12) (see FIG. 2). Also, the rear end that is positioned rearward of the cylindrical body (12) when the plunger member is placed inside the third and fourth internal bores (50c, 50d) provides a rear-end tapered surface (68) having a tapered surface shape whose taper angle is smaller than that of the third circular stepped surface (46c) having a tapered surface on the cylindrical body (12) (see FIG. 2). Furthermore, the exterior periphery of this front-end tapered surface (66) of this body (60) has multiple concave grooves (67) that extend from multiple locations on the outer rim at the base straightforward toward the apex (only one groove is shown in the figure).

Also, the overall length of the body (60) is longer by a specified dimension (typically about 5.0 mm to about 30.0 mm) than the length of the fourth internal bore (50d). The outer diameter of the body (60) is smaller by a specified dimension (typically about 1.0 mm to about 6.0 mm) than the inner diameter of the fourth internal bore (50d) of the body (60). Furthermore, the overall length of the plunger member (58) is smaller by a specified dimension (typically about 5.0 mm to about 30.0 mm) than the total sum of the length of the third internal bore (50c) and that of the fourth internal bore (50d).

On the other hand, the flow-regulating part (62) is made of the same resin material as the body (60) and formed integrally with the rear-end tapered surface (68) of the body (60). This flow-regulating part (62) has a modified hexagonal cylinder shape formed by twisting a short hexagonal cylinder block positioned coaxially with the body (60) around the center of axis of the body (60) so that the opposing end surfaces produce a phase difference of, for example, about 30° (typically about 15° to about 90°). This way, each of the six side faces of the flow-regulating part (62) provides a flow-regulating surface (70) with a curved surface, which is formed by twisting a rectangular plane parallel with the axial direction of the body (60) counterclockwise by, say, 30° around the center of axis of the body (60) as viewed from the rear end face (end face opposite to the body (60)).

This flow-regulating part (62) has an overall size that allows it to be stored inside the third internal bore (50c) of the cylindrical body (12). Moreover, the size of the rear end face having a hexagonal shape is such that the rear end face can cover the through hole (56) in the plunger cap (54) (see FIG. 2).

On the other hand, the connection member (64) provided integrally on the plunger member (58) is made of polyethylene, polypropylene, polyacetal, polyamide, polysulfone or other resin material having resin spring characteristics (exhibiting elastic deformation action), for example. Also provided integrally on this connection member (64) are a bar-like extension/contraction part (72) that projects by a specified length (typically about 2.0 mm to about 10.0 mm) from the rear end face of the flow-regulating part (62) in the axial direction of the body (60), and a bar-like engagement part (74) that extends by a specified length (typically about 3.0 mm to about 10.0 mm) from the tip of the extension/contraction part (72) in both radial directions. In other words, the connection member (64) roughly has an overall shape of a T-shaped bar, where the leg of the T forms the extension/contraction part (72), while the head of the letter T forms the engagement part (74).

In this connection member (64), the extension/contraction part (72) has an outer diameter that is smaller by a specified dimension than the inner diameter of the through hole (56) in the plunger cap (54), and a height that is identical to or smaller by a specified dimension than the thickness of the surface having the groove (57) of the plunger cap (54), which corresponds to the height from the side (front end face) opposite to the surface having the groove (57) to the bottom of the groove (57). Furthermore, the engagement part (74) has a thickness and length that allow it to be inserted into the groove (57) on the plunge cap (54) without projecting outward (see FIG. 2).

Integration of the connection member (64) and plunger member (58) can be easily realized by, for example, inserting the tip of the extension/contraction part (72) into a hole provided at the center of the flow-regulating part (62) and then bonding the tip. It is also possible to integrally form these connection member (64) and plunger member (58). Of course, in this case the connection member (64) and plunger member (58) must be made of the same resin or other material.

Thus, as shown in FIG. 2, the entire plunger member (58) is arranged coaxially inside the internal bore (48) of the cylindrical body (12) in a condition where the rear end of the body (60) and the flow-regulating part (62) are stored inside the third internal bore (50c), while a majority of the body (60) other than the aforementioned rear end is stored inside the fourth internal bore (50d). In this arrangement, the extension/contraction part (72) of the connection member (64) integrated with the plunger member (58) is inserted into the through hole (56) in the plunger cap (54) in a manner allowing extension/contraction, while the connection part (74) is stored in the groove (57) on the plunger cap (54). This causes the plunger member (58) to be connected to the plunger cap (54) via the connection member (64). In other words, the connection member (64) is installed inside the cylindrical body (12) and placed between the plunger cap (54) and plunger member (58).

Based on this connection, the rear end face of the flow-regulating part (62) makes contact with the front end face of the plunger cap (54) in a manner blocking the through hole (56) in the plunger cap (54). Also, a circular hole (76) is formed between the exterior periphery of the extension/contraction part (72) of the connection member (64) and the interior periphery of the through hole (56) in the plunger cap (54). Furthermore, a circular gap (77) is formed between each of the exterior peripheries of the flow-regulating part (62) of the plunger member (58) and rear end of the body (60) and the interior periphery of the third internal bore (50c). Moreover, a narrow cylindrical gap (78) is formed between the exterior periphery of the body (60) and the interior periphery of the fourth internal bore (50d). Also, a space (80) that permits forward/rearward movement of the plunger member (58) is formed between the front-end tapered surface (66) of the body (60) and the fourth circular stepped surface (46d) of the cylindrical body (12).

As shown in FIG. 7, the reagent-introducing medical device (10) in accordance with this embodiment, where the cylindrical body (12) is placed between the syringe (14) and reagent injection catheter (16), allows a reagent (81) discharged from the nozzle (24) of the syringe (14) into the internal bore (48) of the first connection part (18) of the cylindrical body (12) to be guided first into the circular hole (76) formed inside the through hole (56) in the plunger cap (54), as shown by the arrow. This causes the rear end face of the flow-regulating part (62) of the plunger member (58) to be pressured forward by the reagent.

Then, as the reagent pressure rises inside the circular hole (76), the pressure exerted by the reagent (81) on the rear end face of the flow-regulating part (62) eventually rises to a specified level, at which point the extension/contraction part (72) of the connection member (64) deforms elastically in the extending direction. As a result, the flow-regulating part (62) and body (60) of the plunger member (58) move forward with the two receiving a force by the extension/contraction part (72) of the connection member (64) to the rear side. Consequently, a space through which the reagent (81) enters the circular gap (77) inside the third internal bore (50c) is formed between the rear end face of the flow-regulating part (62) and the plunger cap (54).

Then, the reagent (81) entering the circular gap (77) via the space flows through the cylindrical gap (78) formed inside the fourth internal bore (50d), as well as the space (80), and then travels through the fifth internal bore (50e) to eventually flow into the connector (40c) via the second opening (21). As evident from this mechanism, the circular gap (77), cylindrical gap (78), space (80) and fifth internal bore (50e) comprise a channel through which the reagent (81) flows. Also, the circular hole (76) formed inside the through hole (56) in the plunger cap (54) and the second opening (21) comprise an inlet through which the reagent (81) enters the channel, and an outlet through which the reagent (81) exits the channel, respectively.

In the aforementioned reagent-introducing medical device (10), any fluctuation in the flow rate of the reagent (81) flowing through the cylindrical gap (78) inside the fourth internal bore (50d) can be minimized, especially when the reagent (81) is supplied through the nozzle (24) of the syringe (14), even when the reagent pressure inside the circular hole (76) fluctuates significantly.

In other words, when a rising reagent discharge pressure from the syringe (14) or other factor causes the reagent pressure to rise in the circular hole (76), that is, in the area through which the reagent flows into the third internal bore (50c), a larger pressure is applied on the rear end face of the flow-regulating part (62) of the plunger member (58). At this time, while the force applied on the plunger member (58) by the extension/contraction part (72) of the connection member (64) to the rear side increases, the plunger member (58) moves forward. This way, the rise in reagent pressure in the circular hole (76) is absorbed or offset by the increase in the pressure on the plunger member (58) occurring in accordance with the increase in the aforementioned force applied by the extension/contraction part (72), and a pressure loss generates as a result. This minimizes any rise in reagent pressure occurring in the area through which the reagent (81) exits from the circular gap (77) into the cylindrical gap (78) as a result of rising reagent pressure in the circular hole (76). This in turn minimizes any increase in the amount of reagent (81) entering from the circular gap (77) into the cylindrical gap (78) as a result of rising reagent pressure inside the circular hole (76), and consequently minimizes any increase in the reagent flow rate in the cylindrical gap (78).

When a rising reagent discharge pressure from the syringe (14) or other factor causes the plunger member (58) to move forward, the space formed between the rear end face of the flow-regulating part (62) and the front end face of the plunger cap (54) increases. This reduces the speed at which the reagent (81) enters from the circular hole (76) into the space inside the third internal bore (50c) despite the increase in general reagent speed occurring as a result of rising discharge pressure, etc. This in turn minimizes any rise in reagent speed inside the channel (77, 78, 80, 50e) when the speed at which the reagent (81) flows into the third internal bore (50c) (circular gap (77)) increases. As a result, any increase in reagent flow rate inside the channel (77, 78, 80, 50e) can be suppressed in an advantageous manner.

On the other hand, if, for example, a dropping reagent discharge pressure from the syringe (14) or other factor causes the reagent pressure in the circular hole (76) to drop, the pressure applied on the rear end face of the flow-regulating part (62) of the plunger member (58) decreases. At this time, while the force applied on the plunger member (58) by the extension/contraction part (72) of the connection member (64) to the rear side decreases, the plunger member (58) moves rearward, as shown by the two-dot chain line in FIG. 7. This way, the drop in reagent pressure in the circular hole (76) is absorbed or offset by the drop in the pressure on the plunger member (58) occurring in accordance with the decrease in the aforementioned force applied by the extension/contraction part (72), and this minimizes any drop in reagent pressure occurring in the area through which the reagent (81) exits from the circular gap (77) into the cylindrical gap (78) as a result of dropping reagent pressure in the circular hole (76). This in turn minimizes any decrease in the amount of reagent (81) entering from the circular gap (77) into the cylindrical gap (78) as a result of dropping reagent pressure inside the circular hole (76), and consequently minimizes any decrease in reagent flow rate in the cylindrical gap (78). As evident from the above explanation, here the plunger member (58) and connection member (64) comprise a channel control mechanism.

This action to suppress fluctuation in reagent flow rate inside the cylindrical gap (78) as a result of fluctuation in reagent pressure inside the circular hole (76) is dependent on the spring characteristics of the extension/contraction part (72) of the connection member (64), as expressed by a spring constant (K), etc., and the forward/rearward movement stroke (S) of the plunger member (the axial-direction length of the space (80), which corresponds to the dimension from the front-end tapered surface (66) to the fourth circular stepped surface (46d) of the cylindrical body (12) in a condition where the rear end face of the flow-regulating part (62) is contacting the front end face of the plunger cap (54) (see FIG. 2)). If the movement stroke (S) of the plunger member (58) is large where the plunger member (58) is movably stored, the axial dimensions of the third internal bore (50c) and fourth internal bore (50d) through which the reagent (81) flows increase. This causes problems, such as increase in the aforementioned dead space.

Therefore, in this example the movement stroke (S) of the plunger member (58) is adjusted to approximately 0.5 mm (typically about 0.2 mm to about 1.0 mm), while the spring constant (K) of the extension/contraction part (72) of the connection member (64) is adjusted to approximately 4.24 g/mm (typically about 2.0 g/mm to about 10.0 g/mm). This way, the flow rate (Q) of the reagent (81) guided into the reagent injection catheter (16) through the cylindrical body (12) of the reagent-introducing medical device (10) when the syringe (14) with a capacity of 1 mL is manually operated, is limited or controlled to a range of about 10.0 mL/min to about 25.0 mL/min (in another embodiment, about 4.0 mL/min to about 30.0 mL/min). Of course, the size of the movement stroke (S) of the plunger member (58) and spring constant (K) of the extension/contraction part (72) of the connection member (64) are not specifically limited to the values given in this example.

In this embodiment, the reagent flow out of the second opening (21) is not stopped even when the reagent pressure rises excessively in the circular hole (76) as a result of an excessive rise in reagent discharge pressure from the syringe (14), etc., and the plunger member (58) moves forward to a point where the front-end tapered surface (66) of the plunger member (58) contacts the fourth circular stepped surface (46d) of the cylindrical body (12).

This is because even when the front-end tapered surface (66) contacts the fourth circular stepped surface (46d), the reagent (81) is still guided into the fifth internal bore (50e) through the multiple concaved grooves (67) provided on the front-end tapered surface (66). Also, the taper angle of the front-end tapered surface (66) is larger than the taper angle of the fourth circular stepped surface (46d) having a tapered surface, and furthermore the plunger member (58) and cylindrical body (12) are respectively made of different resin materials each having a different modulus of elasticity so that the two repel each other in the event of contact. This structure makes it easy to form a slight gap between the front-end tapered surface (66) and fourth circular stepped surface (46d) even when they are contacting with each other.

In the aforementioned reagent-introducing medical device (10), the reagent (81) supplied from the syringe (14) travels through the apparatus body (12) in a laminar flow.

As commonly known, a liquid traveling through a channel having a circular cross-section forms a laminar flow when its Reynolds number, represented by the ratio of the inertial force of the liquid (vd), which is expressed as a product of fluid velocity (v) and channel diameter (d), to the viscosity of the liquid (dynamic coefficient of viscosity) (ν), is less than approximately 2,300 (i.e., Re=vd/ν<approximately 2,300). Also, the diameter of the channel having a circular cross-section is obtained from the cross-section area of the channel (s). On the other hand, the fluid velocity (v) is defined by the formula v=Q/s (where Q indicates liquid flow rate and s indicates channel cross-section area), and thus can be derived from the flow rate of the liquid (Q). In other words, the Reynolds number (Re) can be derived from the flow rate of the liquid (Q) and the cross-section area of the channel (s). In this example, the flow rate of the reagent (Q) is controlled to a range of approximately 10.0 to 25.0 mL/min, as mentioned above. In the above, the pressure upstream of the plunger cap (54) may be about 3.0 kgf/cm² to about 10.0 kgf/cm².

For the above reason, in this example the diameter or so-called corresponding diameter (diameter when the cross-section area perpendicular to the axial direction is assumed as a circle) of each of the circular hole (76), second opening (21), fifth internal bore (50e), circular gap (77), cylindrical gap (78) and space (80) comprising the reagent inlet, outlet and channel is set in such a way that the Reynolds number (Re) of the reagent flowing through the cylindrical body (12) is kept to less than 2,300 and consequently the reagent (81) travels through the cylindrical body (12) in a laminar flow. Specific exemplary dimensions of these diameters are provided below. The present invention is not limited to these exemplary dimensions.

To be specific, the outer diameter of the extension/contraction part (72) of the connection member (64) is approximately 0.3 mm. Accordingly, the corresponding diameter of the circular hole (76), which is formed between the interior periphery of the through hole (56) having an inner diameter of approximately 1.0 mm and the exterior periphery of the extension/contraction part (72), is set to 0.786 mm. The diameter of the second opening (21) is approximately 0.5 mm.

If the flow rate (Q) is in a range of approximately 10.0 to 25.0 mL/min, the Reynolds number (Re) of the reagent (81) flowing through the circular hole (76) having a corresponding diameter (effective diameter) of approximately 0.786 mm (the dynamic coefficient of viscosity (ν) of the reagent, which contains biological materials, is assumed as 1.05×10⁻⁶ m²/s at room temperature, approximately 298.0 K) is calculated as 269.9 to 674.8, which is less than 2,300. Based on the same flow rate range, the Reynolds number (Re) of the reagent (81) flowing through the second opening (21) having a diameter of approximately 0.5 mm is calculated as 424.4 to 1,061.0, which is also less than 2,300.

In addition, the length of the diagonal line connecting the opposing end faces of the hexagonal shape at the flow-regulating part (62) of the plunger member (58) is approximately 2.9 mm. The outer diameter of the body (60) is approximately 1.9 mm. Furthermore, the axial-direction length of the space (80) and the diameter of the fifth internal bore (50e) are both approximately 0.5 mm. Accordingly, the corresponding diameters of the circular gap (77), cylindrical gap (78), space (80) and fifth internal bore (50e) are set to a range of 0.5 to 0.786 mm, respectively. As a result, the Reynolds number (Re) of the reagent (81) flowing through each part of the channel is kept to a level below 2,300.

Moreover, in this example the volume of the aforementioned dead space formed inside the cylindrical body (12) is kept to a range of approximately 0.01 to 0.03 mL due to the aforementioned settings of the corresponding diameters of the respective parts comprising the inlet, outlet, channel, etc. As evident from the above explanation, in this example the plunger member (58) comprises a channel cross-section area limiting mechanism. Also, this plunger member (58), and the connection member (64) that comprises the aforementioned channel control mechanism along with the plunger member (58), together comprise a first control mechanism.

Here, the Reynolds number (Re) of the reagent (81) flowing through the cylindrical body (12) may only be less than 2,300 in order to create a laminar flow of the reagent (81) inside the cylindrical body (12), and the minimum value is not specifically limited. In other words, the diameters or corresponding diameters of the circular hole (76), second opening (21), fifth internal bore (50e), circular gap (77), cylindrical gap (78) and space (80) comprising the reagent inlet, outlet and channel may be determined as deemed appropriate in accordance with the flow rate or other properties of the reagent (81) so that the Reynolds number (Re) is below 2,300.

However, if this Reynolds number (Re) is too small, the fluid velocity drops significantly in the cylindrical body (12). This presents problems, one of which is that the time needed to inject the reagent (81) into the patient body through the reagent injection catheter (16) becomes excessively long.

To prevent such problems, the Reynolds number (Re) may desirably be set to 50 or above, or more desirably to 500 or above. In other words, the diameters or corresponding diameters of the respective parts comprising the reagent inlet, outlet and channel may preferably be set in such a way that the Reynolds number (Re) of the reagent (81) flowing through the cylindrical body (12) is kept in a range of 50≦Re<2,300, or more preferably in a range of 500≦Re<2,300. The maximum Re may vary by ±20% depending on the target liquid and the configurations of the cylindrical body and the plunger member, etc.

With the aforementioned reagent-introducing medical device (10), after entering the third internal bore (50c) the reagent (81) comes out of the circular hole (76) and first flows in the radial direction along the end face of the flow-regulating part (62), as shown in FIG. 7. Then, as it passes through the circular gap (77) in the third internal bore (50c), the reagent (81) contacts the multiple flow-regulating surfaces (70) of the flow-regulating part (62) and changes its flow direction in accordance with these flow-regulating surfaces (70). In other words, the flow direction of the reagent (81) is deflected by, say, 30° counterclockwise around the center of axis of the body (60) when viewed from its rear end face, and a rotational flow is created as a result. And, this rotational reagent flow enters the cylindrical gap (78) and travels through the cylindrical gap (78), space (80) and fifth internal bore (50e) while turning counterclockwise. In other words, the multiple flow-regulating surfaces (70) of the flow-regulating part (62) comprise a second control mechanism (rotational-flow generation mechanism).

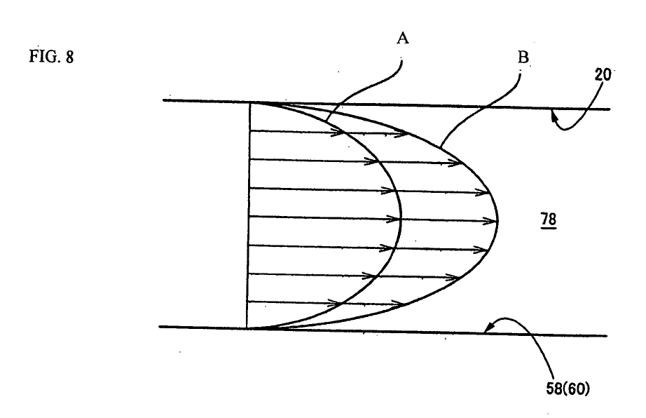

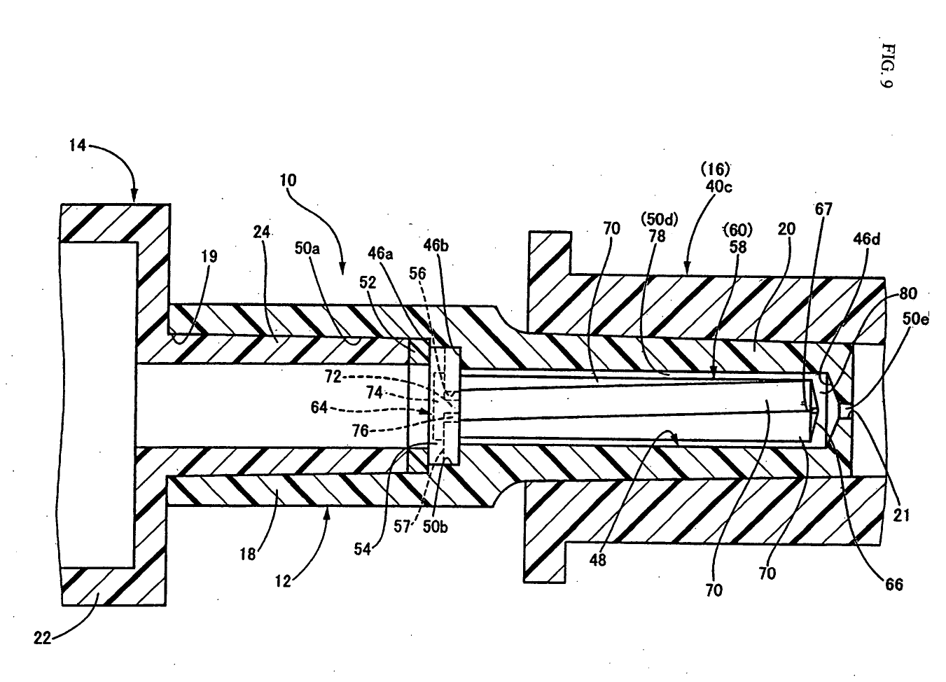

As explained above, the reagent-introducing medical device (10) conforming to this example allows the reagent (81) supplied from the nozzle (24) of the syringe (14) to travel in a laminar flow through the circular gap (77), cylindrical gap (78), space (80) and fifth internal bore (50e) comprising the reagent channel inside the cylindrical body (12). Therefore, the fluid velocities in the respective channel parts (77, 78, 80, 50e) become the highest at the centers of the respective channel parts (77, 78, 80, 50e), and a parabolic velocity distribution where the fluid velocity decreases gradually toward the exterior periphery of the plunger (58) or interior periphery of the cylindrical body (12) is obtained, as evident from solid line A in FIG. 8 that shows a fluid velocity distribution model of the reagent (81) in the cylindrical gap (78) representing all channel parts (77, 78, 80, 50e). As a result, damage to the biological materials contained in the reagent (81), when a reagent (81) containing biological materials such as cells is caused to flow through the respective channel parts (77, 78, 80, 50e) as explained above, can be eliminated or suppressed in an advantageous manner.

In addition, this embodiment of the reagent-introducing medical device (10) causes the laminar reagent flow inside the cylindrical body (12) to contact the multiple flow-regulating surfaces (70) of the plunger member (58) in the circular gap (77) to create a rotational flow. For this reason, the reagent speeds in the cylindrical gap (78), space (80) and fifth internal bore (50e), which are located downstream, in the reagent flow direction, of the circular gap (77) in the channel inside the cylindrical body (12), are further increased at the centers of the respective channel parts (78, 80, 50e). In other words, the parabolic fluid velocity distribution in the respective channel parts (77, 78, 80, 50e) becomes sharper, as shown by solid line B in FIG. 8. As a result, the biological materials such as cells contained in the reagent (81) collect near the center of flow when the reagent flows through the cylindrical body (12), and consequently attachment of the biological materials to the exterior periphery of the plunger member (58) or interior periphery of the cylindrical body (12) in the respective reagent channel parts (78, 80, 50e) can be effectively prevented or suppressed.

Accordingly, the reagent-introducing medical device (10) in accordance with this embodiment, when connected to the syringe (14) and reagent injection catheter (16) to introduce the reagent (81) supplied from the syringe (14) into the reagent injection catheter (16), allows as much biological material as possible contained in the reagent (81) to be introduced into the reagent injection catheter (16) in a healthy, minimally damaged state and in a manner causing virtually no biological materials to be left inside the cylindrical body (12). This effectively increases the amount of biological materials injected into the patient body through the reagent injection catheter (16) as well as the survival rate of such biological materials in the patient body. As a result, the desired effect of an applicable treatment, procedure or other operation that involves injection of a reagent (81) into the patient body can be achieved in a more efficient and reliable manner.

Also, the aforementioned reagent-introducing medical device (10) is designed in such a way that the overall length of the cylindrical body (12) is minimized while ensuring a length that achieves reliable connection of the first and second connection parts (18, 20) with the nozzle (24) of the syringe (14) and connector (40c) on the reagent injection catheter (16), respectively, as well as a sufficient movement stroke of the plunger member (58) movably stored in the cylindrical body (12). Also, the diameters and corresponding diameters of the circular hole (76), second opening (21), fifth internal bore (50e), circular gap (77), cylindrical gap (78) and space (80) comprising the reagent inlet, outlet and channel inside the cylindrical body (12) are kept small in order to keep the aforementioned dead space formed in the cylindrical body (12) to a very small volume of approximately 0.01 to 0.03 mL. This also effectively prevents or suppresses retention inside the cylindrical body (12) of the biological materials contained in the reagent (81) supplied into the cylindrical body (12).

Furthermore, in this example the multiple flow-regulating surfaces (70) of the flow-regulating part (62) that causes the reagent (81) supplied into the cylindrical body (12) to form a rotational flow, and the connection member (64) having the extension/contraction part (72) to apply a force to the rear side on the plunger member (58) that moves forward as the reagent (81) enters the cylindrical body (12), are both provided integrally with the plunger member (58). This allows for reduction of the overall size of the cylindrical body (12) in which these members are stored. The small cylindrical body (12) thus achieved reduces the dead space and improves the overall handling ease of the reagent-introducing medical device (10) in an advantageous manner.

Moreover, the reagent-introducing medical device (10) in accordance with this embodiment allows its structure, which converts the reagent flow in the cylindrical body (12) to a laminar flow and to a rotational flow, to be realized simply using the plunger member (58), the connection member (64) having the extension/contraction part (72) that applies a force to the rear side on the plunger member (58) during its forward movement, and the multiple flow-regulating surfaces (70) formed integrally with the plunger member (58). For this reason, the aforementioned superior features can be demonstrated with an extremely simple structure in an economically advantageous manner, without having to use any complex, expensive member, mechanism or other structure.

In the aforementioned embodiment of the reagent-introducing medical device (10), the flow-regulating part (62), plunger member (58) and connection member (64) are integrated, and also the connection member (64) is integrally assembled with the plunger cap (54). This structure provides the benefit of improving the ease of assembly of these members with the cylindrical body (12).

In addition, the connection member (64) integrated with the plunger member (58) is positioned inside the through hole (56) in the plunger cap (54). This allows the cylindrical body (12) to be made smaller than when the connection member (64) is provided separately from the location of the plunger cap (54) inside the cylindrical body (12). This in turn effectively reduces the dead space.

Also, the reagent-introducing medical device (10) in accordance with this embodiment has all its component members made of resin materials. This prevents generation of rust or other negative effects on the human body caused by, for example, contact between the component members and a specific reagent (81). Therefore, safety of the apparatus during use can be effectively enhanced.

Furthermore, the reagent-introducing medical device (10) in accordance with this embodiment minimizes fluctuation in regent flow rate in the cylindrical gap (78) inside the fourth internal bore (50d) even when the reagent pressure in the circular hole (76) or the speed at which the reagent (81) enters the circular gap (77) fluctuates. This allows the reagent (81) supplied from the syringe (14) to be discharged at as constant a rate as possible from the second opening (12) even when the syringe (14) is operated manually.

Therefore, in addition to reagents containing biological materials, this reagent-introducing medical device (10) can also be used favorably for the introduction into an injection catheter (16) or other injectors of arrhythmia drugs (such as verapamil hydrochloride and disopyramide phosphate) that do not demonstrate sufficient effect unless injected slowly into the patient body.

These embodiments of the reagent-introducing medical device offer the following effects and advantages. In an embodiment of reagent-introducing medical device conforming to the present invention, the reagent flowing through the channel in the apparatus body has a laminar flow by means of flow control by the first control mechanism. For this reason, the apparatus in accordance with this embodiment has a parabolic velocity distribution where the fastest reagent flow occurs at the center of the channel and the speed gradually decreases toward the interior walls of the channel. Therefore, when a reagent containing biological materials such as cells flows through the channel, damage to the biological materials in the reagent can be eliminated or suppressed in an advantageous manner.

In a further embodiment of the reagent-introducing medical device, the laminar reagent flow in the channel is further rotated by means of flow control by a second control mechanism. For this reason, the fluid velocity at the center of the channel is further increased in this reagent-introducing medical device in accordance with this embodiment. This makes the differential fluid velocity between the center of the channel and near the interior walls of the channel more prominent. As a result, when a reagent containing biological materials such as cells flows through the channel, attachment of the biological materials to the interior walls of the channel can be prevented or suppressed in a more effective manner.

Accordingly, the reagent-introducing medical device in accordance with this embodiment, when used with a reagent injector to supply a reagent, such as a reagent containing biological materials, into the patient body, allows as much biological material as possible contained in the reagent entering the channel of the reagent-introducing medical device to be introduced into the reagent injector in a healthy, minimally damaged state and in a manner causing virtually no biological materials to be left inside the channel. This effectively increases the amount of biological material injected into the patient body through the reagent injector as well as the survival rate of such biological materials in the patient body. As a result, the desired effect of an applicable treatment, procedure or other operation that involves injection of a reagent into the patient body can be achieved in a more efficient and reliable manner.

In further aspects of the reagent-introducing medical device, a rotational reagent flow can be easily and reliably achieved inside the channel. Also, the second control mechanism that enables this superior feature can be realized using a simple structure in an easy, economically advantageous manner by simply allowing the reagent to flow in a manner contacting the flow-regulating surfaces, without using any special apparatus or apparatus.

In another aspect of the reagent-introducing medical device, a laminar reagent flow can be achieved inside the channel in a reliable manner.

Furthermore in another aspect of the reagent-introducing medical device, significant slowdown in the reagent flow inside the channel can be prevented. This in turn effectively prevents the utility of the apparatus from dropping as a result of increased time needed to inject the reagent into the patient body.

In another aspect of the reagent-introducing medical device, the actual cross-sectional area of the channel can be effectively reduced by using an inexpensive, simple structure comprising a plunger member stored and arranged movably inside the channel. Furthermore, this plunger member having this simple structure moves in concert with an elastic member that is arranged in such a manner as to apply a force to the inlet side of the plunger member, or in other words to the direction opposite to the direction of motion inside the channel, so as to maintain the reagent flow rate inside the channel within a range not exceeding a specified value.

For the above reasons, the apparatus in accordance with this embodiment maintains the maximum Reynolds number of the reagent flowing through the channel at a low level, without having to use any complex or expensive member, mechanism or other structure. The Reynolds number is calculated from the cross-section area of the channel and the reagent flow rate, or more specifically from the diameter of the channel, assuming that the channel has a circular cross-section shape, and the flow rate of the reagent flowing through the channel. This way, a laminar reagent flow in the channel can be achieved in a reliable manner.

Therefore, this reagent-introducing medical device in accordance with this embodiment is able to, in a more economically advantageous manner, introduce a reagent containing biological materials into a reagent injector, and eventually into the patient body, by keeping the biological materials in the reagent in a healthy state.

This reagent-introducing medical device in accordance with this embodiment has the plunger member arranged inside the reagent channel for limiting or controlling the cross-section area of the channel and flow rate in the channel. Therefore, the size of the entire apparatus can be advantageously minimized compared with when the plunger member is provided in a different location outside the channel. This minimizes the space where biological materials may remain when a reagent containing biological materials is used.

In view of the above, this reagent-introducing medical device in accordance with this embodiment can reduce or completely eliminate in a more effective manner the amount of biological materials remaining inside the apparatus when a reagent containing biological materials is introduced into the reagent injector.

In another aspect of the reagent-introducing medical device, ease of handling of the plunger member and elastic member, as well as ease of assembly of these members with the apparatus body, can be enhanced in an advantageous manner.

In another aspect of the reagent-introducing medical device, the elastic member is positioned at the inlet and therefore the space that would otherwise have been occupied by the elastic member if it were installed in the channel is eliminated. Therefore, compared with when the entire elastic member is installed inside the channel, for example, the size of the channel, or the space where biological materials may remain when a reagent containing biological materials is used, can be effectively reduced.

In another aspect of the reagent-introducing medical device, the length of the channel can be limited to the total sum of the length and movement stroke of the plunger member. This allows the channel to be kept to the minimum required length. This again makes it possible to effectively reduce the space where biological materials may remain when a reagent containing biological materials is used.

In further aspects of the reagent-introducing medical device, a rotational reagent flow in the channel can be achieved in an easy and reliable fashion simply by allowing the reagent to flow in such a manner as to contact the flow-regulating surfaces. In addition, there is no need to provide, in the channel separately from the plunger member, a member that changes the reagent flow in the channel into a rotational flow. This effectively reduces the size of the channel, or the space where biological materials may remain when a reagent containing biological materials is used.

In another aspect of the reagent-introducing medical device conforming to the present invention, the actual cross-section area of the channel can be effectively reduced by using an inexpensive, simple structure comprising a plunger member stored and arranged movably inside the cylindrical apparatus body. Furthermore, the plunger member having this simple structure moves in concert with an elastic member that is arranged in such a manner as to apply a force to the plunger member in a direction opposite to the direction of motion inside the apparatus body, so as to maintain the reagent flow rate inside the channel within a range not exceeding a specified value. Furthermore, the plunger member provides a rotational-flow generation mechanism for creating a rotational reagent flow inside the apparatus body.

Therefore, the reagent-introducing medical device in accordance with this embodiment is able to, in a more economically advantageous manner, introduce a reagent containing biological materials into a reagent injector, and eventually into the patient body, by keeping the biological materials in the reagent in a healthy state. This also minimizes the space where biological materials in the reagent may remain. Therefore, the apparatus can reduce or completely eliminate in a more effective manner the amount of biological materials remaining inside the apparatus when a reagent containing biological materials is introduced into the reagent injector.

In another aspect of the reagent-introducing medical device, a rotational flow can be achieved in the apparatus body in an easier and more reliable manner.

In another aspect of the reagent-introducing medical device conforming to the present invention, a circular or cylindrical gap is formed between the cylindrical exterior periphery of the body and the interior periphery of the apparatus body. This way, the actual cross-sectional area of the channel can be reduced in an easier and more reliable manner.

The discussion above described specific embodiments of the present invention in detail. It should be noted that these are only exemplary and the present invention is not limited by the descriptions provided above.

For example, in the aforementioned examples all of the component members of the reagent-introducing medical device (10) are made of resin materials. However, the materials of these component members are not limited to resin materials. It is acceptable to have at least one of these component members formed by aluminum, aluminum alloy or other metal material. Of course, any resin material can be selected to form each component member, as deemed appropriate, in addition to the resin materials cited in the examples.

Also, it presents no problem at all to provide the reagent injector (10) integrally with the syringe (14) or other reagent supply apparatus.

Furthermore, the reagent-introducing medical device (10) can also be structured in such a manner as to allow the reagent injector to be connected directly, by integrally forming the connector (40c) with the reagent-introducing medical device (10), or by allowing the second connection part (20) to be connected directly to the reagent injection catheter (16) or other reagent injector.

Moreover, the specific structure of the body (12) of the reagent-introducing medical device (10) is not specifically limited to those used in the examples. In other words, the body (12) need not have a cylindrical shape as long as a channel through which a reagent (81) can flow is provided in the body (12) and this channel has an inlet and outlet through which a reagent (81) enters and exits the channel, respectively.

Also, more than one inlet and/or more than one outlet can be provided in the body (12).

In addition, the structure of the elastic member that applies a force to the rear side (inlet side) when the plunger member moves forward is in no way limited to those structures used in the embodiments. For example, a mass or block-shaped elastic member or spring-shaped elastic member can be placed between the front-end tapered surface (66) of the plunger member (58) and the fourth circular stepped surface (50d) of the cylindrical body (12). In this case, the elastic member is compressed or deformed as the plunger member (58) moves forward, thus applying a force on the plunger member (58) to the rear side. Of course, the connection member (64) can be omitted in this structure.

Furthermore, it goes without saying that the material of the elastic member is in no way limited to resin.

It is also possible to form the body (60) of the plunger member (58) that reduces the diameter or corresponding diameter of the reagent channel in the cylindrical body (12), using a separate member, independent of the member comprising the flow-regulating part (62) of the plunger member (58) that creates a rotational reagent flow in the cylindrical body (12).

In addition, the shape of the flow-regulating part (62) is not specifically limited to those used in the aforementioned embodiments. For example, it is possible to twist a block having a polygonal cylinder shape other than hexagonal cylinder (such as an octagonal cylinder) around the center of axis so that the opposing end faces form a phase difference corresponding to a specified angle, and use the resulting modified polygonal cylinder shape as the flow-regulating part, with the side faces of the aforementioned flow-regulating part forming flow-regulating surfaces. In other words, the number of flow-regulating surfaces is in no way limited.

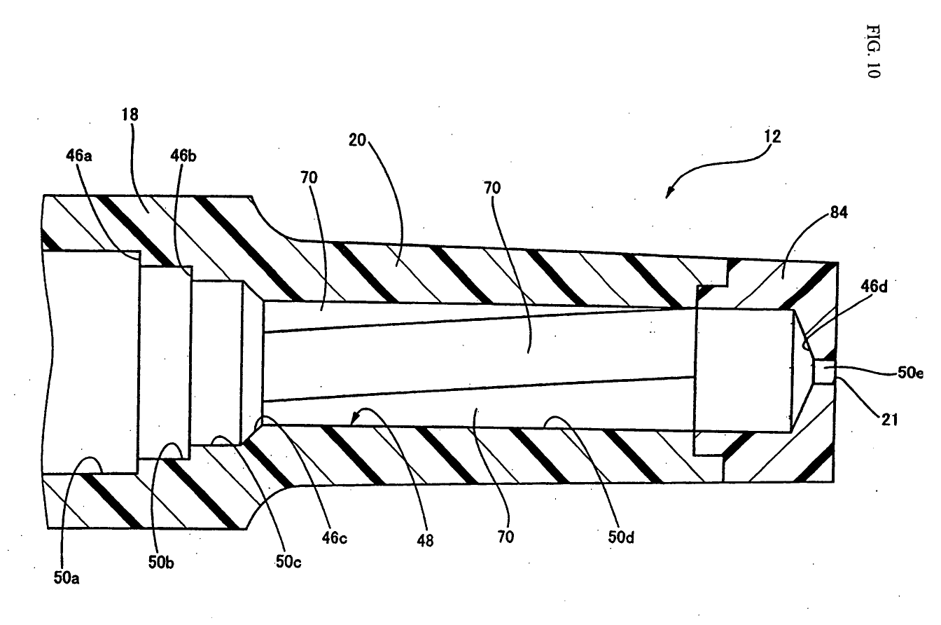

Also, a flow-regulating part with multiple flow-regulating surfaces (70) can be provided on the exterior periphery of the body (60) of the plunger member (58). In other words, the body (60) of the plunger member (58) can be a modified polygonal cylinder shape formed by twisting an elongated polygonal cylinder around the center of axis so that the opposing end faces form a phase difference corresponding to a specified angle, as shown in FIG. 9. This way, each of the multiple side faces of the body (60) can be used as a flow-regulating surface (70) with a curved surface that is formed by twisting a rectangular plane parallel with the body (60) in the axial direction around the center of axis of the body (60) by a specified angle. Of course, it presents no problem to provide such flow-regulating surfaces (70) only on one part of the body (60). In this case, the circular gap (77), which is provided as a dedicated space at the flow-regulating part (62) in the first example mentioned above, can be omitted. This way, the dead space can be reduced further.

Furthermore, multiple flow-regulating surfaces (70) can also be provided on the interior periphery of the cylindrical body (12). For example, the interior periphery of the cylindrical gap (78) can have a shape corresponding to the exterior periphery shape of the aforementioned modified polygon shape, as shown in FIG. 10. In other words, it is possible to form multiple curved surfaces, each formed by twisting a rectangular plane parallel with the axial direction around the center of axis of the cylindrical body (12) by a specified angle, and use these curved surfaces to comprise the flow-regulating surfaces (70). Of course, these flow-regulating surfaces (70) can be provided over the entire interior periphery of the cylindrical body (12) or only on one part thereof. In the reagent-introducing medical device shown in FIG. 10, the cylindrical body (12) comprises an integrated part providing the first connection part (18) and second connection part (20), and a cap (84) in which the second opening (21) is formed, in order to form the flow-regulating surfaces (70) on the interior periphery of the cylindrical body (12).

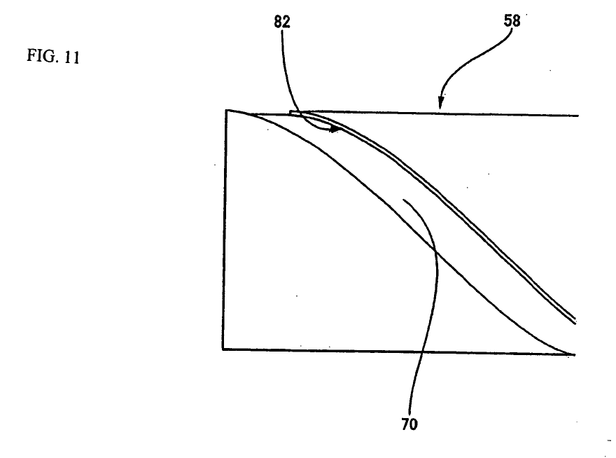

Also, it is possible to provide, on the exterior periphery of the body (60) of the plunger member (58), a spiral groove (82) extending spirally along the flow direction of reagent (81) in the cylindrical body (12), as shown in FIG. 11, and use the bottom face of this spiral groove (82) to form a flow-regulating surface (70). In other words, it is possible to form flow-regulating surfaces using curved surfaces extending spirally along the flow direction of reagent (81). Of course, such flow-regulating surfaces (70) having spirally extending curved surfaces can be formed on the interior periphery of any channel part of the cylindrical body (12) comprising the reagent channel.

In addition, the aforementioned embodiments illustrates specific examples of applying the present invention to a reagent-introducing medical device that is connected to a reagent injection catheter to inject a reagent into lesions in cardiac muscle, etc. Of course, the present invention can also be used by connecting a reagent injector other than a reagent injection catheter, such as a syringe that injects a reagent into areas of the human body other than lesions in the cardiac muscle, etc.

The present invention includes the above mentioned embodiments and other various embodiments including the following:

An embodiment of the present invention provides a reagent-introducing medical device that connects to a reagent injector for injecting a specified reagent into the patient body and guides the reagent into the reagent injector, wherein this reagent-introducing medical device comprises: (a) an apparatus body having a channel through which the reagent flows, an inlet through which the reagent enters the channel, and an outlet through which the reagent exits from the channel; (b) a first control mechanism for controlling the flow of the reagent in the channel so that the reagent flows in a laminar form through the channel in the apparatus body; and (c) a second control mechanism for controlling the flow of the reagent in the channel so that the reagent flows in a rotating motion through the channel in the apparatus body.

In another embodiment of the reagent-introducing medical device, the second control mechanism comprises flow-regulating surfaces that contact the reagent flowing through the channel in the apparatus body and change the flow direction of the reagent, wherein each of the flow-regulating surfaces has a curved surface formed by twisting a plane parallel with the flow direction of the reagent around an axis running in parallel with the flow direction.

In another embodiment of the reagent-introducing medical device, the second control mechanism comprises flow-regulating surfaces that contact the reagent flowing through the channel in the apparatus body and change the flow direction of the reagent, wherein each of the flow-regulating surfaces has a curved surface extending spirally along the flow direction of the reagent.

In another embodiment of the reagent-introducing medical device, the cross-section areas of at least the inlet and outlet are set in such a way that the maximum Reynolds number of the reagent flowing through the channel becomes smaller than the Reynolds number at which the reagent flow changes from laminar flow to turbulent flow, and wherein the first control mechanism comprises a flow-rate control mechanism for controlling the flow rate of the reagent by limiting the cross-section area of the channel using a channel cross-section area limiting mechanism.

In another embodiment of the reagent-introducing medical device, the maximum Reynolds number of the reagent flowing through the channel is controlled by the first control mechanism to remain within a range of about 50 or more but less than about 2,300.

In another embodiment of the reagent-introducing medical device, the channel cross-section area limiting mechanism comprises a plunger member arranged inside the channel in such a way that it moves in the direction of separating from the inlet when the reagent flows into the channel, while the flow-rate control mechanism comprises the plunger member and an elastic member that applies a force on the plunger member to the inlet side.

In another embodiment of the reagent-introducing medical device, the plunger member and elastic member are integrated with each other.

In another embodiment of the reagent-introducing medical device, the elastic member is positioned at the inlet between the apparatus body and plunger member.

In another embodiment of the reagent-introducing medical device, the plunger member is arranged inside the channel in such a way that it blocks the inlet when the reagent does not flow into the channel.

In another embodiment of the reagent-introducing medical device conforming to the present invention, the second control mechanism comprises flow-regulating surfaces that are formed on the interior periphery of the apparatus body or exterior periphery of the plunger member so that these flow-regulating surfaces contact the reagent flowing through the channel in the cylindrical apparatus body and change the flow direction of the reagent, and wherein each of the flow-regulating surfaces has a curved surface formed by twisting a plane parallel with the flow direction of the reagent around an axis running in parallel with the flow direction.

In another embodiment of reagent-introducing medical device conforming to the present invention, the second control mechanism comprises flow-regulating surfaces that are formed on the interior periphery of the apparatus body or exterior periphery of the plunger member so that these flow-regulating surfaces contact the reagent flowing through the channel in the cylindrical apparatus body and change the flow direction of the reagent, and wherein each of the flow-regulating surfaces has a curved surface extending spirally along the flow direction of the reagent.

To solve the technical problems mentioned above, an embodiment provides a reagent-introducing medical device that connects to a reagent injector for injecting a specified reagent into the patient body and guides the reagent into the reagent injector, wherein this reagent-introducing medical device comprises: (a) a cylindrical apparatus body that introduces the reagent from an inlet and discharges the reagent from an outlet; (b) a plunger member arranged inside the apparatus body in such a way that it moves in the direction of separating from the inlet when the reagent is introduced from the inlet; (c) a rotational-flow generation mechanism installed on the plunger member and causing the reagent introduced into the apparatus body to form a rotational flow inside the apparatus body; and (d) an elastic member positioned between the plunger member and apparatus body and applying a force on the plunger member to the inlet side.

In another embodiment of the reagent-introducing medical device, the rotational-flow generation mechanism comprises a modified polygonal cylinder formed by twisting a polygonal cylinder extending in the axial direction of the plunger by a specified angle around the center of axis of the plunger, and wherein the flow of the reagent in the apparatus body forms a rotational flow when the reagent flows into the apparatus body in such a manner as to contact the modified polygonal cylinder.

In another embodiment of the reagent-introducing medical device, the plunger member comprises a body having a cylindrical exterior periphery.

The present application is based on Japanese Patent Application No. 2004-199046, filed Jul. 6, 2004, the disclosure of which is incorporated by reference in its entirety.

Although all possible embodiments are not listed, the present invention can be implemented in different embodiments that incorporate various changes, corrections and modifications based on the knowledge of those skilled in the art. It should be clearly understood that the forms of the present invention are illustrative only and not intended to limit the scope of the present invention. Modifications to these embodiments are also included in the scope of the present invention, as long as they do not deviate from the spirit of the present invention.

What is claimed is:

1. A reagent-introducing medical device for controlling the injection of a reagent into the human body, comprising:
an apparatus body having a channel through which the reagent flows, an inlet through which the reagent enters the channel, and an outlet through which the reagent exits from the channel; and
a pressure control valve configured to elastically control pressure of the reagent in the channel of the apparatus body.

2. The reagent-introducing medical device of claim 1, wherein the pressure control valve is disposed upstream of the channel.

3. The reagent-introducing medical device of claim 1, wherein the channel has a ring-shaped cross section.

4. The reagent-introducing medical device of claim 3, wherein the apparatus body comprises a cylindrical body and a plunger member inserted in the cylindrical body, and the channel is defined between an inner wall of the cylindrical body and an outer wall of the plunger member.

5. The reagent-introducing medical device of claim 4, wherein the pressure-control valve is provided on or constituted by an upstream end of the plunger member which is elastically movable in an axial direction as the pressure of the liquid in the channel is controlled by the pressure-control valve.

6. The reagent-introducing medical device of claim 5, wherein the apparatus body further comprises a plunger cap having a through-hole, and a distance between the plunger cap and the pressure-control valve is elastically changeable.

7. The reagent-introducing medical device of claim 6, wherein the pressure-control valve is coupled to the plunger cap with an elastic member.

8. The reagent-introducing medical device of claim 1, wherein the inlet, the pressure-control valve, the channel, and the outlet are configured to maintain the maximum Reynolds number of the reagent flowing through the channel below the Reynolds number at which the reagent flow changes from laminar flow to turbulent flow.

9. The reagent-introducing medical device of claim 8, wherein the maximum Reynolds number, Re=vd/ν, of the reagent flowing through the channel is between about 50 and about 2,300 wherein v is fluid velocity of the reagent, d is effective channel diameter, and ν is dynamic coefficient of viscosity of the reagent, as measured when ν is about 1.05×10⁻⁶ m²/s and a flow rate is about 10.0 to about 25.0 mL/min wherein.

10. The reagent-introducing medical device of claim 1, further comprising a flow-direction control mechanism configured to apply rotational motion to the reagent when flowing through the channel in the apparatus body.

11. The reagent-introducing medical device of claim 10, wherein the flow-direction control mechanism comprises flow-regulating surfaces that contact the reagent upstream of the channel in the apparatus body and change the flow direction of the reagent, each of the flow-regulating surfaces having a curved or angled surface formed by twisting a plane parallel with the flow direction of the reagent around an axis running in parallel with the flow direction.

12. The reagent-introducing medical device of claim 11, wherein the flow-regulating surfaces are disposed at the pressure-control valve.

13. The reagent-introducing medical device of claim 10, wherein the flow-direction control mechanism comprises flow-regulating surfaces that contact the reagent when flowing through the channel in the apparatus body and change the flow direction of the reagent, each of the flow-regulating surfaces having a curved surface extending spirally along the flow direction of the reagent.

14. The reagent-introducing medical device of claim 4, wherein the plunger member has an outer surface having flow-regulating surfaces that change the flow direction of the reagent when flowing through the channel, each of the flow-regulating surfaces having a curved surface extending spirally along the flow direction of the reagent.

15. The reagent-introducing medical device of claim 1, which is configured to be connected between a syringe nozzle and a reagent injection catheter connector.

16. A reagent-introducing medical device for controlling the injection of a reagent into the human body, comprising:
an approximately cylindrical apparatus body for introducing the reagent from an inlet and discharges the reagent from an outlet;
a plunger member arranged inside the apparatus body, which is movable in a direction of separation from the inlet when the reagent is introduced from the inlet;
a rotational-flow generation mechanism installed on the plunger member and causing the reagent introduced into the apparatus body to form a rotational flow inside the apparatus body; and
an elastic member positioned between the plunger member and the apparatus body and applying a force to the inlet side of the plunger member.

17. The reagent-introducing medical device of claim 16, wherein the rotational-flow generation mechanism comprises a modified polygonal cylinder formed by twisting a polygonal cylinder extending in the axial direction of the plunger by a specified angle around the center of axis of the plunger, and wherein the polygonal cylinder comes into contact with the reagent flowing in the apparatus body and imparts a rotational flow thereto.

18. The reagent-introducing medical device of claim 16, wherein the plunger member comprises a body having an approximately cylindrical exterior periphery.

19. A reagent-introducing medical device for controlling the injection of a reagent into the human body, comprising:
an apparatus body having a channel through which the reagent flows, an inlet through which the reagent enters the channel, and an outlet through which the reagent exits from the channel; and
a first control means for causing laminar flow of the reagent through the channel in the apparatus body.

20. The reagent-introducing medical device of claim 19, further comprising a second control means for applying rotational motion to the reagent flow through the channel in the apparatus body.

21. The reagent-introducing medical device of claim 20, wherein the second control means comprises flow-regulating surfaces that contact the reagent flowing through the channel in the apparatus body and change the flow direction of the reagent, each of the flow-regulating surfaces having a curved or angled surface formed by twisting a plane parallel with the flow direction of the reagent around an axis running in parallel with the flow direction.

22. The reagent-introducing medical device of claim 20, wherein the second control means comprises flow-regulating surfaces that contact the reagent flowing through the channel in the apparatus body and change the flow direction of the reagent, each of the flow-regulating surfaces having a curved surface extending spirally along the flow direction of the reagent.

23. The reagent-introducing medical device of claim 19, wherein the first control means comprises a flow-rate control means for controlling the flow rate of the reagent by limiting the cross-section area of the channel using a channel cross-section area limiting mechanism.

24. The reagent-introducing medical device of claim 23, wherein the channel cross-section area limiting mechanism comprises a plunger member arranged inside the channel to be movable in a direction of separating from the inlet when the reagent flows into the channel, while the flow-rate control means comprises the plunger member and an elastic member that applies a force to the inlet side of the plunger member.

25. The reagent-introducing medical device of claim 24, wherein the plunger member and the elastic member are integrated with each other.

26. The reagent-introducing medical device of claim 24, wherein the elastic member is positioned at the inlet and between the apparatus body and the plunger member.

27. The reagent-introducing medical device of claim 24, wherein the plunger member is configured to block the inlet when the reagent does not flow into the channel.

28. A method for controlling the injection of a reagent into a human body, comprising:
passing the reagent through a channel configured to cause laminar flow of the reagent before injection of the reagent into the human body.

29. The method of claim 28, further comprising imparting rotational motion to the reagent as it passes through said channel.

30. The method of claim 28, wherein the passing step comprises maintaining the maximum Reynolds number of the reagent flowing through the channel within a range of about 50 to less than about 2,300.
